(19) United States
(12) Patent Application Publication
(10) Pub. No.: US 2012/0248201 A1
(43) Pub. Date: Oct. 4, 2012

(54) DUAL-INTERFACE SMART CARD

(75) Inventor: Carl Mario Sutera, Meredith, NH (US)

(73) Assignee: AMERICAN BANK NOTE COMPANY, Columbia, TN (US)

(21) Appl. No.: 13/517,712

(22) Filed: Jun. 14, 2012

Related U.S. Application Data
(63) Continuation-in-part of application No. 13/362,090, filed on Jan. 31, 2012.
(60) Provisional application No. 61/463,897, filed on Feb. 24, 2011.
(60) Provisional application No. 61/462,238, filed on Jan. 31, 2011.

(51) Int. Cl. G06K 19/077

(52) U.S. Cl. 235/492

(57) ABSTRACT

A dual-interface smart card comprises an integrated circuit (IC) module coupled to a plastic card body. The IC module includes multiple contact pads that are electrically coupled to corresponding sections of a radio frequency (RF) antenna incorporated into the card body. Each contact pad is electrically connected to the RF antenna by a pair of opposing conductive elements, with one conductive element being permanently welded to the contact pad and the other permanently welded to the antenna. Each conductive element is in the form of a multi-stranded braided wire that is frayed at each end, the frayed ends of opposing conductive elements entangling each other upon assembly to establish redundant, resilient electrical connection between the contact pad and the antenna. To further increase the reliability of the connection between each contact pad and the antenna, the entangled frayed ends of opposing conductive elements are encapsulated within a conductive filler material.

### CROSS-REFERENCE TO RELATED APPLICATIONS

The present application is a continuation-in-part of U.S. patent application Ser. No. 13/362,090, which was filed on Jan. 31, 2012 in the name of Carl Mario Sutera, which in turn claims the benefit of U.S. Provisional Patent Application Ser. No. 61/463,897, which was filed on Feb. 24, 2011 in the name of Carl Mario Sutera and U.S. Provisional Patent Application Ser. No. 61/462,238, which was filed on Jan. 31, 2011 in the name of Carl Mario Sutera, the disclosure for each of the above-identified applications being incorporated herein by reference.

### BACKGROUND

The present invention relates generally to the plastic card manufacturing industry and, more specifically, to the manufacture of dual-interface smart cards.

Smart cards are well known devices that include a plastic card body into which is embedded an integrated circuit (IC). The integrated circuit is designed to store data that can be used, inter alia, to provide the card with electronic identification, authentication, data storage and application processing capabilities. As a result, smart cards are widely used in commerce to provide information and/or application processing capabilities in connection with, but not limited to, bank cards, credit cards, health insurance cards, driver's licenses, transportation cards, loyalty cards and membership cards.

The card body for a smart card is typically constructed out of one or more layers of any durable plastic material, such as polyvinyl chloride (PVC), acrylonitrile butadiene styrene (ABS) or polycarbonate. The dimensions of the card body are typically similar to the dimensions of a conventional credit card (i.e., 3.370 inches in length, 2.125 inches in width and 0.030 inches in thickness).

The integrated circuit (IC) is typically constructed as part of an integrated circuit (IC) module that includes a lead frame having a bottom surface on which the integrated circuit is fixedly mounted using a chip adhesive. The exposed portion of the IC is in turn encapsulated within a hard epoxy resin for protective purposes. As part of the smart card manufacturing process, the IC module is mounted, chip side down, into a fitted recess that is milled or otherwise formed into the top surface of the card body and is fixedly held in place using a hot melt adhesive.

Smart cards of the type as described above transmit data stored on the integrated circuit using either (i) a direct contact interface (the resultant products being commonly referred to in the art as contact smart cards), (ii) a contact-free interface (the resultant products being commonly referred to in the art as contactless smart cards) or (iii) a hybrid of the two aforementioned interfaces (the resultant products being commonly referred to in the art as dual-interface smart cards).

The contact interface for a dual-interface smart card is typically constructed as a plurality of gold-plated contact pads that are fixedly mounted onto the top surface of the lead frame and are arranged to form a total contact surface area of approximately 1 square centimeter. The underside of each contact pad is individually electrically connected to the integrated circuit by a corresponding gold-plated wire, the wires being encapsulated by a hard epoxy resin for protective purposes. As such, it is to be understood that the contact pads serve as an electrical interface for the IC when the smart card is inserted into an appropriate reader.

The contact-free interface for a dual-interface smart card is typically provided by a conductive antenna that is incorporated into the card body by any suitable means, such as through the use of embedding, etching, plating, printing or the like. Preferably, the antenna is arranged in a coiled, or spiraled, configuration around the IC module cavity and is, in turn, electrically connected to the integrated circuit, as will be described further in detail below. Accordingly, in response to an interrogation signal, information stored on the integrated circuit can be transmitted by the antenna as a radio frequency (RF) signal.

As noted above, the integrated circuit for a dual-interface smart card must be electrically connected to the antenna to effectively transmit data. Typically, a pair of opposing metal contact pads are mounted onto the underside of the lead frame, each contact pad being individually electrically connected to the integrated circuit by a corresponding gold-plated wire which is then encapsulated within a hard epoxy resin for protective purposes. The card body is then drilled, or routed, to the extent necessary so that the conductive component of the antenna is externally exposed at two separate locations.

Various techniques are known in the art for electrically connecting each contact pad formed on the underside of the IC module with a corresponding exposed portion of the antenna.

One such technique involves overfilling each routed hole with a conductive epoxy material that creates a convex protrusion or bump in direct alignment with each of the contact pads formed on the underside of the IC module. Accordingly, when the IC module is permanently affixed to the card body, an electrical connection is established between the integrated circuit and the antenna through the conductive epoxy.

The above-described method for electrically connecting the IC module to the antenna has been found in the industry to be largely unsatisfactory. Specifically, the conductive epoxy has been found to fragment, crack or otherwise break at one or both of its connection points in response to torsion or stress applied to the smart card during use and/or testing. As a result of the electrical disconnection of the IC module from the antenna, the smart card loses its RF signal transmission capabilities, which is highly undesirable.

In response, a number of alternative approaches for electrically connecting the IC module to the antenna have been implemented in the smart card manufacturing industry. However, these alternative approaches have been found to similarly suffer from a number of notable shortcomings including: (i) being considerably labor-intensive and time-consuming in nature, (ii) requiring the purchase of additional manufacturing equipment, and/or (iii) utilizing glues with limited shelf time.

Accordingly, it is an object of the present invention to provide a relatively inexpensive smart card that is flexible enough to support some stress but, at the same time, has the requisite structural integrity to maintain a strong physical connection of the IC module to the antenna.

### SUMMARY OF THE INVENTION

It is an object of the present invention to provide a new and improved dual-interface smart card.

It is another object of the present invention to provide a new and improved dual-interface smart card that is durable in nature and designed to maintain the requisite internal electrical connectivity between components in response to torsion and stress applied thereto.

It is yet another object of the present invention to provide a dual-interface smart card that has a limited number of parts and is cost-effective to manufacture.

Accordingly, as a feature of the present invention, there is provided a smart card, the smart card comprising (a) a card body, the card body comprising an antenna, (b) an integrated circuit (IC) module coupled to the card body, the IC module comprising an IC chip and a contact pad electrically coupled to the IC chip, and (c) a first conductive element for electrically coupling the IC module to the antenna, the first conductive element being permanently conductively coupled to one of the antenna and the contact pad, the first conductive element having a first end that is adapted to resiliently electrically contact the other of the antenna and the contact pad, the first conductive element being adapted to flex to the extent necessary to maintain electrical contact with the other of the antenna and the contact pad upon movement of the IC module relative to the card body.

Additional objects, as well as features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings, wherein like reference numerals represent like parts:

FIG. 1 is a top plan view of a first embodiment of a dual-interface smart card constructed according to the teachings of the present invention;

FIG. 2 is an enlarged, exploded, fragmentary, cross-section view of the dual-interface smart card shown in FIG. 1;

FIG. 3 is a top view of the card body shown in FIG. 1, the card body being shown without its pair of conductive connectors for simplicity purposes only;

FIG. 4 is a section view of the IC module shown in FIG. 2;

FIGS. 5(a) and 5(b) are front and top views, respectively, of one of the conductive connectors shown in FIG. 2;

FIG. 6 is a top view of the pair of conductive connectors shown in FIG. 2, the pair of conductive connectors being shown disposed together in a nested configuration, the pair of conductive connectors being shown with a supply of conductive silicone disposed therebetween, the supply of conductive silicone being represented in dashed form for ease of illustration;

FIG. 7 is a fragmentary, top view of a modification to the conductive connector shown in FIG. 5(b), the connector being shown with a circular weld area about which the connector is conductively coupled to either the IC module or the antenna, the weld area being shown in dashed form for ease of illustration;

FIG. 8 is an enlarged, exploded, fragmentary cross-section view of a second embodiment of a dual-interface smart card constructed according to the teachings of the present invention; and

FIG. 9 is a fragmentary, bottom view of the RF inlay shown in FIG. 8.

### DETAILED DESCRIPTION OF PREFERRED EMBODIMENTS

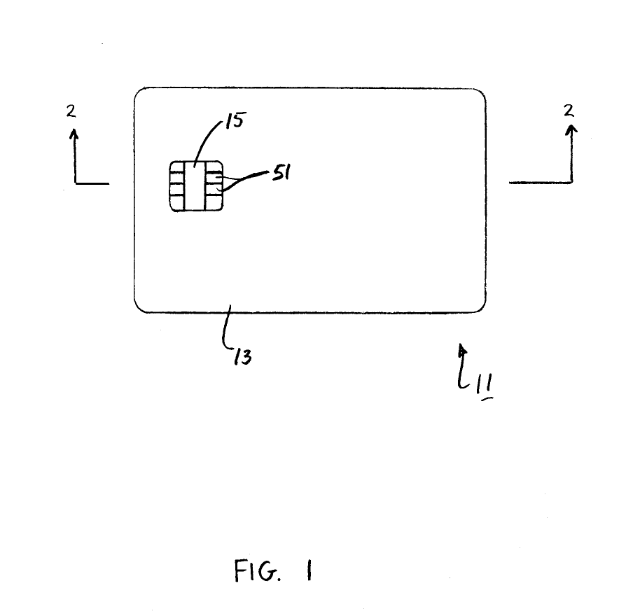

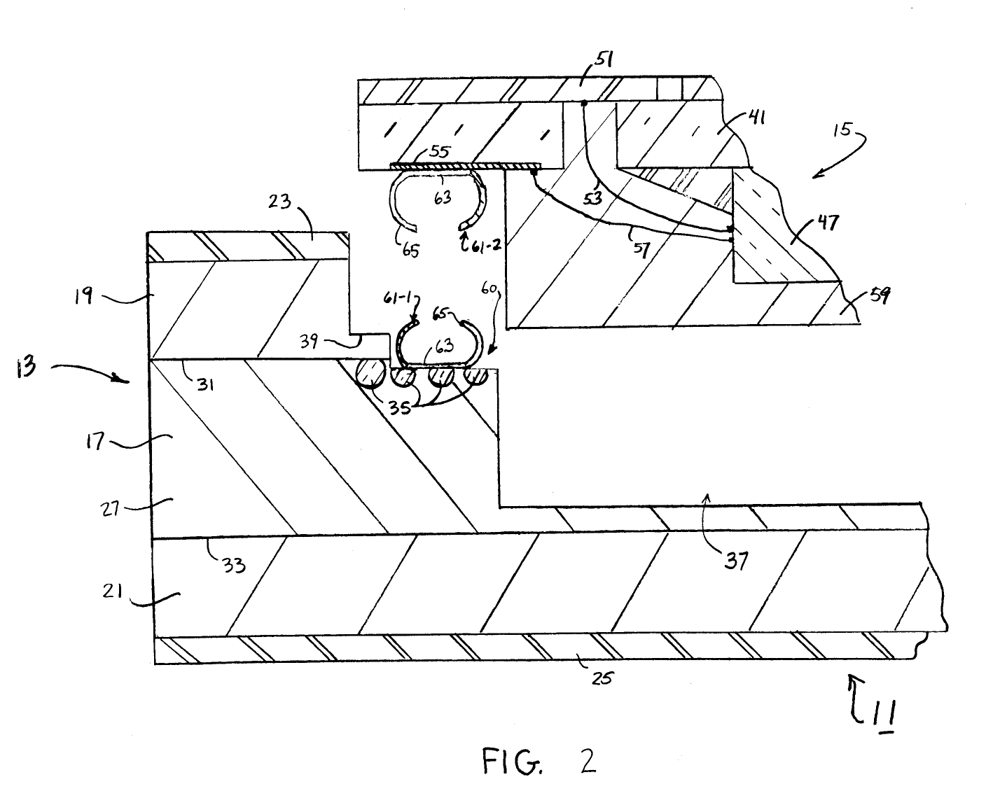

Referring now to FIGS. 1 and 2, there are shown top plan and exploded, fragmentary, cross-section views of a first embodiment of a dual-interface smart card constructed according to the teachings of the present invention, the first embodiment dual-interface smart card being identified generally by reference numeral 11. As will be described further below, smart card 11 is capable of transmitting stored electronic data using either a direct contact interface or a contact-free interface.

Dual-interface smart card 11 comprises a plastic card body 13 and an integrated circuit (IC) module 15 fixedly mounted into card body 13, as will be described further below.

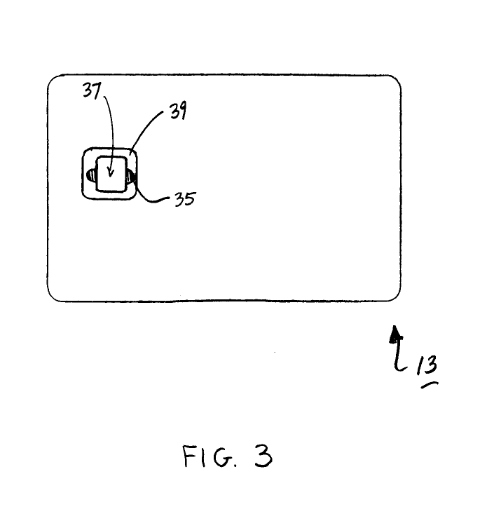

As seen most clearly in FIGS. 2 and 3, card body 13 is constructed out of a plurality of layers of any durable plastic material, such as polyvinyl chloride (PVC), acrylonitrile butadiene styrene (ABS) or polycarbonate. The dimensions of card body 13 are preferably similar to the dimensions of a conventional credit card (i.e., 3.370 inches in length, 2.125 inches in width and 0.030 inches in thickness).

Card body 13 comprises a radio frequency (RF) inlay 17 that is disposed between a top print layer 19 and a bottom print layer 21. In addition, a pair of opposing transparent overlays 23 and 25 is disposed on the top and bottom surfaces, respectively, of the stack. It should be noted that layers 17, 19, 21, 23 and 25 are then permanently joined together by any conventional means, such as through a lamination process, to form the unitary card body 13.

It should be noted that card body 13 is not limited to the number and arrangement of layers as described herein. Rather, it is to be understood that the number, construction and dimensions of the individual layers could be modified without departing from the spirit of the present invention as long as the overall dimensions of card body 13 remain generally the same (i.e., 3.370 inches in length, 2.125 inches in width and 0.030 inches in thickness).

RF inlay 17 includes a core layer 27 that is preferably constructed of a polyvinyl chloride (PVC) material that is approximately 350 μm in thickness, core layer 27 comprising a substantially flat top surface 31 and a substantially flat bottom surface 33. As seen most clearly in FIG. 2, a radio frequency antenna 35 is incorporated into core layer 27. Specifically, RF antenna 35 is preferably in the form of a 100 μm diameter copper wire that is embedded into top surface 31 and arranged in a coiled configuration around the periphery of core layer 27. As will be described further in detail below, antenna 35 is electrically connected to IC module 15 to provide smart card 11 with RF transmission capabilities in the frequency range of approximately 13.56 MHz.

It should be noted that non-insulated copper wire (i.e., copper wire that is not wrapped with an outer insulated sheath) is preferably used to form RF antenna 35. If a segment of the copper wire is required to cross over one or more strands of the remainder of antenna 35, a quantity of insulating material, such as a quick-set, non-conductive material (e.g., an ultraviolet (UV) cure adhesive), is disposed therebetween to prevent RF antenna 35 from experiencing a possible short condition. As will be described further in detail below, the use of non-insulated copper wire allows for one end of antenna 35 to terminate into a densely arranged, even contacting, spiral which, in turn, can serve as a region of contact with IC module 15, thereby eliminating the need to affix a contact pad thereto as part of an additional manufacturing process. By contrast, the use of an insulated copper wire would prohibit use of antenna 35 as a contact region unless its insulated sheath is removed at the proposed area of contact and, in turn, applied with an individually die cut contact pad, the aforementioned process having been found to be both time-consuming and costly in nature.

Each of top and bottom print layers 19 and 21 is preferably constructed out of a 200 μm thick white PVC material. As can be appreciated, layers 19 and 21 are adapted to receive printed matter to identify and decorate card 11.

In addition, each of top and bottom overlays 23 and 25 is preferably constructed out of a 50 μm thick transparent PVC material. As can be appreciated, overlays 23 and 25 are designed to protect card body 13 from common environmental conditions.

As seen in both FIGS. 2 and 3, card body 13 is shaped to define a generally rectangular module cavity, or recess, 37 that is dimensioned to fittingly receive module 13 (i.e., the cavity being approximately 13.4 mm in length by approximately 12.3 mm in width). Cavity 37 is formed into card body 13 by any conventional means, such as through a milling process, and extends down from the top surface of top print layer 19 to a depth that is nearly the entire thickness of core layer 27. A narrow shelf, or mounting surface, 39 is formed into top print layer 19 around the periphery of cavity 37 in order to support IC module 15, as will be described further below.

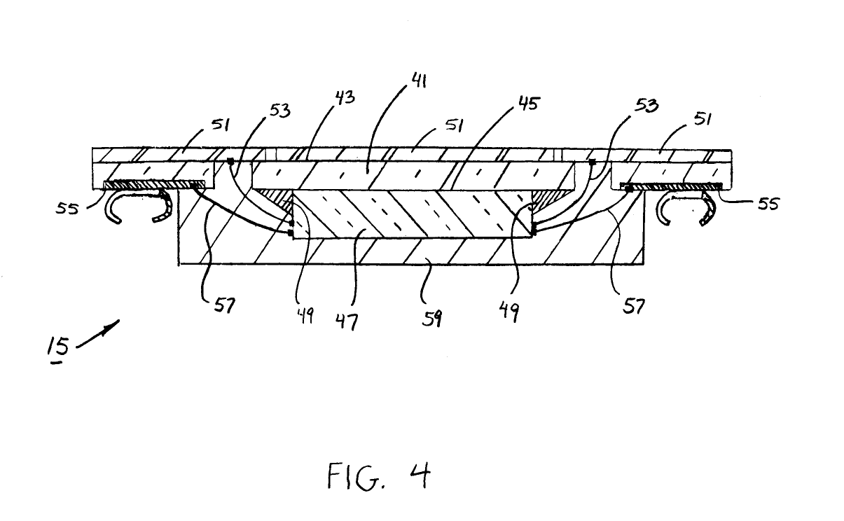

Referring now to FIG. 4, IC module 15 comprises a lead frame 41 that includes a top surface 43 and a bottom surface 45. An integrated circuit chip 47 is in turn fixedly secured onto bottom surface 45 of lead frame 41 by a chip adhesive 49.

A plurality of gold-plated contact pads 51 are fixedly mounted onto top surface 43 of lead frame 41 and are arranged to form a total contact surface area of approximately 1 sq cm. It should be noted that the underside of each contact pad 51 is electrically connected to IC chip 47 by a corresponding gold-plated wire 53, thereby enabling a corresponding reader (not shown) to retrieve electronic data from IC chip 47 through contact pads 51.

In addition, a pair of gold-plated contact pads 55 is fixedly mounted onto bottom surface 45 of lead frame 41 at opposite ends, each contact pad 55 being electrically connected to IC chip 47 by a corresponding gold-plated wire 57. An encapsulation material 59, such as a hard epoxy resin, is deposited over IC chip 47 as well as wires 53 and 57 to protect the sensitive components and ensure that adequate connectivity is maintained.

Referring back to FIG. 2, a pair of bores 60 (only one of which is shown in FIG. 2) is routed, or drilled, down into shelf 39. As can be seen, each bore 60 is drilled a depth that is sufficient to expose a segment of copper wire antenna 35 and a gap region that is approximately 213 um. As will be described in detail below, the exposed portion of antenna 35 is conductively coupled to each of contact pads 55, thereby providing IC module 15 with RF transmission capabilities. Although not shown herein, it is to be understood that a conductive contact pad could be mounted onto the exposed segments of antenna 35 to facilitate connection therewith.

Preferably, smart card 11 is assembled in the following manner. Specifically, card body 13 is preferably formed from the plurality of laminates as described in detail above. In turn, card body 13 is shaped to define module cavity 37 by any conventional means, such as through a milling process. Furthermore, the pair of bores 60 is routed, or drilled, down into shelf 39 at a depth that is sufficient to expose a segment of the strands of copper wire antenna 35.

IC module 15 is then mounted, chip 47 side down, onto shelf 39 with each contact pad 55 on the underside of lead frame 41 disposed in direct alignment with a corresponding exposed segment of RF antenna 35, as shown in FIG. 2. Preferably, a hot melt (not shown) is utilized to permanently join IC module 15 to card body 13 to yield the unitary card 11.

As a principal feature of the present invention, smart card 11 relies upon a novel means for connecting bottom contact pads 55 with the exposed segments of RF antenna 35, the details of the connection means to be described in detail below. It is to be understood that the novel connection means provides smart card 11 with enough flexibility to support bending stress without compromising the requisite structural integrity of the internal physical connections, which is an object of the present invention.

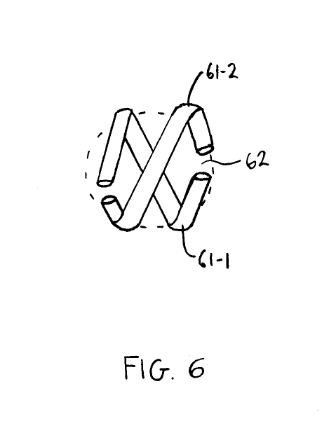

Specifically, referring now to FIG. 2, the novel connection means utilizes first and second opposing conductive elements, or connectors, 61-1 and 61-2 as well as a supply of conductive filler material 62 (shown in dashed form in FIG. 6) that encapsulates at least a portion of elements 61. For purposes of simplicity only, a single pair of conductive elements 61 is shown joining one contact pad 55 to exposed segments of RF antenna 35. However, it is to be understood that an identical pair of conductive elements 61 and filler material 62 is preferably used to similarly join the other contact pad 55 to exposed segments of RF antenna 35 at a separate location.

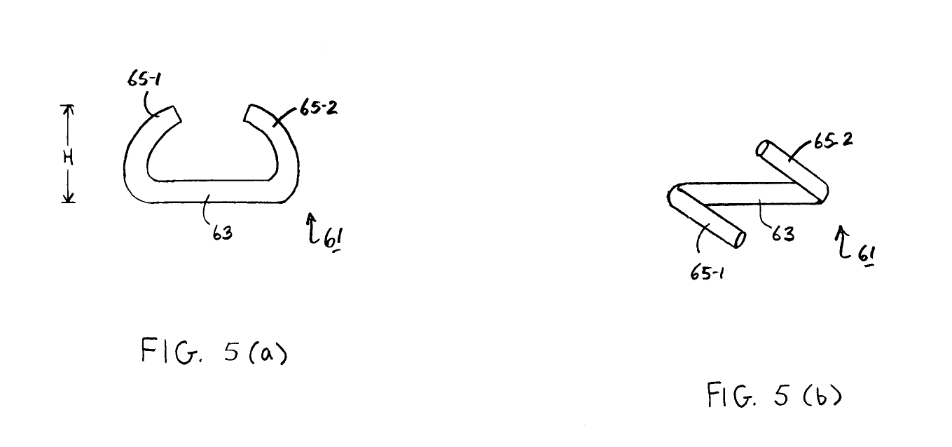

As seen most clearly in FIGS. 5(a) and 5(b), each conductive element 61 is preferably constructed out a length of thin wire (e.g., 100 micron in diameter) that is formed from a highly conductive material, such as gold, copper or aluminum. Although conductive element 61 is represented herein as wire that is generally circular in transverse cross-section, it is to be understood that alternate types of conductive elements (e.g., flattened, ribbon-type conductive elements) could be used in place thereof without departing from the spirit of the present invention.

Each conductive element 61 has a generally U-shaped, staple-like configuration with a straightened base portion, or support, 63 and a pair of resilient spring arms, or flexible contact members, 65-1 and 65-2 formed at opposite ends of base portion 63. Spring arms 65 curve inward towards one another, as seen most clearly in FIG. 5(a). However, it should be noted that spring arms 65 extend laterally outward in opposing directions, as seen most clearly in FIG. 5(b), so as to provide conductive element 61 with a somewhat spiral, or helical, overall configuration. As can be appreciated, the outward lateral orientation of spring arms 65 serves to, inter alia, (i) expose base portion 63 as a region for conductive contact and (ii) prevent interference between spring arms 65 when a pair of conductive elements 61 is nested tightly together, as shown in FIG. 6.

It is to be understood that curvature of each spring arm 65 allows for its flexion downward upon receiving a suitable compressive force thereon, with each spring arm 65 resiliently returning to its original configuration upon withdrawal of such a compressive force. In this capacity, the resilient, spring-biased nature of each arm 65 enables each conductive element 61 to maintain direct contact with a complementary conductive item (e.g., antenna 35, pad 55 and/or opposing element 61) even when compression and separation forces are applied thereto. Because it has been found that the IC module in a conventional smart card is prone to slight movement relative to its card body, the utilization of spring-like contact arms 65 herein to maintain direct physical contact between IC module 15 and antenna 35 over time (i.e., even upon repeated movement of IC module 15 relative to card body 13) serves as an important feature of the present invention.

It should be noted that each conductive element 61 is not limited to the slightly spiraled, staple-like configuration as represented herein. Rather, it is to be understood that each conductive element 61 could be alternatively configured without departing from the spirit of the present invention. However, it is preferred that modified versions of conductive elements 61 similarly utilize contact members with resilient characteristics. For example, rather than an arcuate design, each arm 65 could have an alternative configuration that enables direct electrical contact to be maintained between contact pad 55 and antenna 35 even upon slight movement of IC module 15 relative to card body 13, such as a resilient coil, loop, tube, piston, sphere or the like, without departing from the spirit of the present invention.

It should also be noted that each conductive element 61 is represented herein as comprising two spring arms 65 to create redundancy in its points of physical connection. Accordingly, if one spring arm 65 should become disconnected from its opposing conductive item, it is to be understood that the direct contact established with the conductive element 61 can be adequately retained through its other arm 65, which is highly desirable.

However, it should be noted that each conductive element 61 is not limited to a dual-arm construction. Rather, it is to be understood that the number of spring arms 65 for each conductive element 61 could be increased or decreased without departing from the spirit of the present invention. For example, each conductive element 61 could be alternatively include additional spring arms in order to increase the total number of connection points and overall contact surface area, thereby improving the reliability of the connection over time, which is highly desirable.

Referring back to FIG. 2, base portion 63 of first conductive element 61-1 is permanently welded to one or more strands of exposed RF antenna 35 by any conventional means, such as ultrasonic welding, with its opposing spring arms 65 directed upwards for electrical contact with contact pad 55 through either (i) direct contact with contact pad 55 and/or (ii) direct contact with second conductive element 61-2 (thereby resulting in the indirect contact with contact pad 55). It should be noted that each spring arm 65 for first conductive element 61-1 preferably has a height H that is greater than the depth of routed bore 60, thereby enabling each spring arm 65 to extend beyond shelf 39 and into direct conductive contact against opposing conductive element 61-2 and/or contact pad 55 when smart card 11 is in its fully assembled form, which is highly desirable.

Similarly, base portion 63 of second conductive element 61-2 is permanently welded to contact pad 55 by any conventional means, such as ultrasonic welding, with its opposing spring arms 65 directed downward towards for electrical contact with one or more strands of exposed RF antenna 35 through either (i) direct contact with antenna 35 and/or (ii) direct contact with first conductive element 61-1 (thereby resulting in the indirect contact with antenna 35). Preferably, each spring arm 65 for second conductive element 61-2 similarly has a height H that is greater than the depth of routed bore 60, thereby enabling each spring arm 65 to extend down into direct conductive contact against opposing conductive element 61-1 and/or one or more strands of exposed RF antenna 35 when smart card 11 is in its fully assembled form, which is highly desirable.

Preferably, conductive elements 61-1 and 61-2 are oriented in an offset relationship so that spring arms 65 do not interfere with one another as base portions 63 are drawn towards one another. As a result, conductive elements 61-1 and 61-2 can nest, or crash, tightly together, as shown in FIG. 6, with each spring arm 65 drawn firmly against one or more complementary conductive items (e.g., antenna 35, pad 55 and/or a portion of an opposing conductive element 61).

In addition, a supply of conductive filler material 62 is deposited into routed bore 60 so as to encapsulate at least a portion of spring arms 65 of first and second conductive element 61-1 and 61-2. Filler material 62 is preferably constructed of a low durometer conductive silicone that is approximately 5 um in thickness. Due to its inherent softness, it is to be understood that conductive filler material 62 is able to receive substantial torsion forces without experiencing degradation of its physical structure (i.e., without cracking, fragmenting, breaking or the like). As a result, by permanently welding each conductive element 61 at one end and, in turn, encapsulating its opposite end with soft filler material 62, it is to be understood that a strong connective bond is established between IC module 15 and RF antenna 35 that is able to withstand considerable torsion forces, which is highly desirable. In addition to its conductive properties, filler material 62 protects conductive elements 61-1 and 61-2 from oxidation and other forms of contamination that can jeopardize conductivity.

It should be noted that filler material 62 is not limited to a low durometer conductive silicone. Rather, it is to be understood that filler material 62 could be formed from any conventional conductive material with considerable softness and flexibility that enables it to withstand stress (e.g., mercury) without departing from the spirit of the present invention.

As a principal feature of the present invention, connective redundancy is utilized to conductively couple IC module 15 to antenna 35. Specifically, each contact pad 55 is conductively coupled to one or more exposed strands of antenna 35 using both (i) the direct physical contact of each spring arm 65 against one or more complementary conductive items (e.g., antenna 35, pad 55 and/or a portion of an opposing conductive element 61) and (ii) conductive filler material 62 to encapsulate at least a portion of opposing conductive elements 61. Stated another way, even when IC module 15 experiences significant motion relative to card body 13, electrical connection is adequately maintained between IC module 15 and RF antenna 35 through either direct, physical, metal-on-metal spring contact and/or the use of conductive filler material 62. As a result of the aforementioned connective redundancy, smart card 11 is rendered less susceptible to failure than traditional smart cards that rely upon a single means of electrically connecting an IC module to an RF antenna.

It should be noted that the details relating to the construction of smart card 11 are intended to be merely exemplary. Accordingly, it is to be understood that those skilled in the art shall be able to make numerous variations and modifications to smart card 11 without departing from the spirit of the present invention. All such variations and modifications are intended to be within the scope of the present invention as defined in the appended claims.

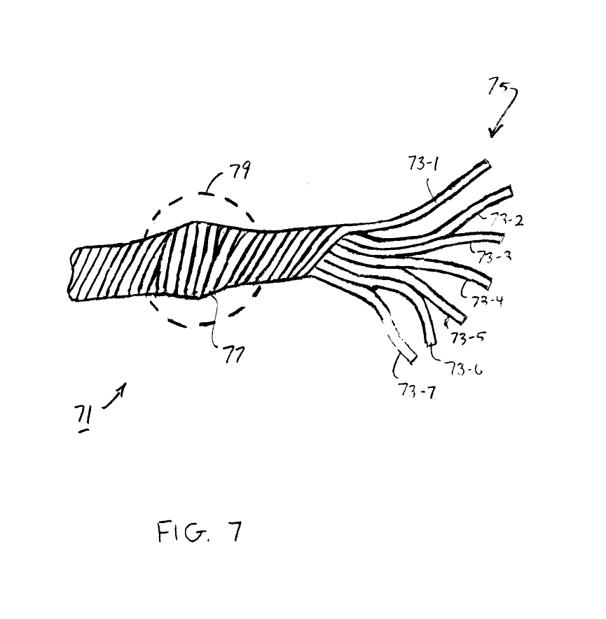

For example, as referenced briefly above, it is to be understood that each conductive element 61 could be alternatively configured without departing from the spirit of the present invention. Specifically, referring now to FIG. 7, there is shown a fragmentary, top view of another type of conductive element 71 that could be utilized in smart card 11 in place of each conductive element 61. As will be described further below, conductive element 71 is similar to conductive element 61 in that conductive element 71 provides redundant, resilient contact means that enables direct electrical contact to be maintained between contact pad 55 and antenna 35 even upon slight movement of IC module 15 relative to card body 13.

Conductive element 71 differs from conductive element 61 in that, inter alia, conductive element 71 is formed using a multi-stranded, braided wire rather than a single solid wire. As can be seen, conductive element 71 preferably includes seven individual conductive strands 73-1 thru 73-7 that are tightly braided or otherwise interwoven, each strand 73 being preferably in the form of a tin-plated copper wire.

Strands, or contact members, 73 are braided together to form a unitary conductive element 71, approximately 100-150 μm in diameter, that includes opposing free ends 75 (with only one end 75 being shown in FIG. 7 for ease of illustration). As can be seen, each end 75 is preferably frayed (i.e., partially unbraided) to create a brush-like configuration of individual strands 73, with each strand 73 preferably at least partially bent, or curved, at each end 75 to create a more resilient, or flexible, form of connection. It should also be noted that the configuration of strands 73 at each end 75 is preferably random and not in a predetermined geometric pattern in order to maximize connectivity, as will be explained further below.

Conductive elements 71 are utilized in a similar fashion to conductive elements 61 to maintain connection between contact pad 55 on IC module 15 and antenna 35 on card body 13. Specifically, an intermediate section 77 for a first conductive element 71 is permanently welded to an exposed portion of RF antenna 35 on card body 13, the region of spot welding in relation to intermediate section being identified in FIG. 7 as dashed circle 79. Similarly, intermediate section 77 for a second conductive element 71 is permanently welded to contact pad 55 on IC module 15. Welded as such, it is to be understood that the brush-like ends 75 for the first conductive element 71 are bent, or otherwise disposed, to form a resilient, or spring-like, curvature that is directed towards the brush-like ends 75 for the second conductive element 71 (the ends 75 of which are similarly bent with a resilient curvature that is directed towards ends 75 of first conductive element 71).

As part of the assembly process, filler material 62 is deposited between IC module 15 and card body 13. Immediately thereafter, IC module 15 is mounted onto shelf 39 in card body 13 so that preferably (i) the ends 75 of the conductive element 71 welded to contact pad 55 resiliently contact the exposed portion of RF antenna 35, (ii) the ends 75 of the conductive element 71 welded to RF antenna 35 resiliently contact pad 55 and (iii) the ends 75 of the opposing pair of conductive elements 71 further entangle, or crash, together in a nested relationship, thereby creating numerous additional points of direct contact, which is desirable for reasons to be described further below. Due to the random pattern of strands 75 at each end 77, IC module 15 can be mounted onto shelf 39 with a minimal alignment requirement, thereby simplifying the assembly process.

As can be appreciated, the utilization of a multi-stranded, braided conductive element 71 that is frayed at each end 75 in place of a single, solid wire (e.g., conductive element 61) introduces a number of notable advantages.

As a first advantage, it is to be understood that the utilization of a random array of resilient contact between opposing brush-like ends 75 of conductive elements 71 creates greater redundancy, and hence reliability, of the contact established between IC module 15 and antenna 35. Specifically, because each end 75 includes a brush-like contact with seven randomly configured conductive strands 73, a total of twenty-eight strands, or whiskers, 73 extend between antenna 35 and each contact pad 55. Since IC module 15 includes two separate contact pads 55, fifty-six conductive whiskers 73 are available not only for direct connection between IC module 15 and antenna 35 but also as interfacial sites for receiving silicone filler material 62. As a result of this connective redundancy, the electrical connection established between IC module 15 and antenna 35 is rendered highly reliable, which is a principal object of the present invention.

As a second advantage, it is to be understood that multi-stranded braided construction of conductive element 71 allows for its deformation in spot weld section 77. More particularly, conductive element 71 is able to substantially flatten within section 77. The flattening of conductive element 71 serves to (i) increase the surface area of section 77 for bonding (resulting in an increase in the overall strength of the bond), (ii) enable conductive element 71 to more efficiently and conveniently fit within the narrow, shallow bore 60 routed into shelf 39 that extends between card body 13 and IC module 15, and (iii) allow for deformation of conductive element 71, as needed, during the assembly process and thereby minimize the likelihood of conductive element 71 otherwise damaging either card body 13 and/or IC module 15.

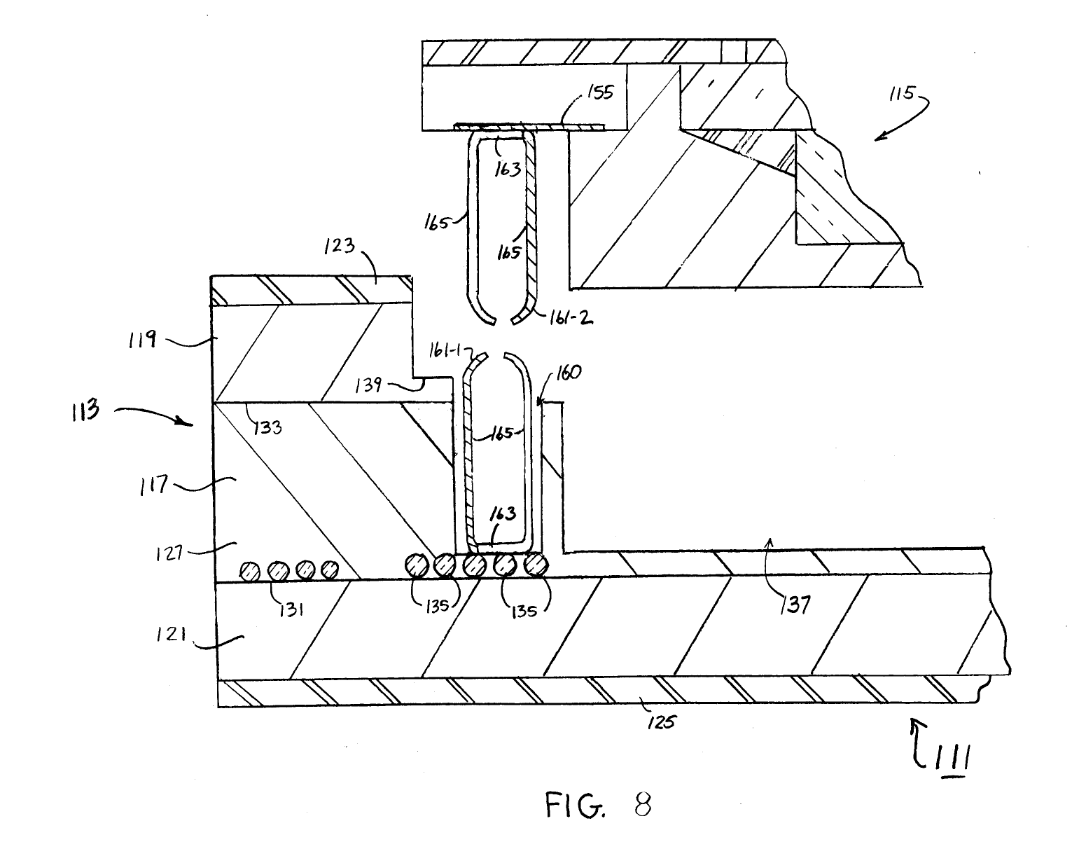

Referring now to FIG. 8, there is shown an exploded, fragmentary, cross-section view of another embodiment of a dual-interface smart card constructed according to the teachings of the present invention, the dual-interface smart card being identified generally by reference numeral 111. As will be described further below, smart card 111 is capable of transmitting stored electronic data using either a direct contact interface or a contact-free interface.

As can be seen, smart card 111 is similar to smart card 11 in that smart card 111 comprises a plastic card body 113 that is adapted to fixedly receive an integrated circuit (IC) module 115.

Plastic card body 113 is similar to plastic card body 13 in that plastic card body 113 comprises a radio frequency (RF) inlay 117 that is disposed between a top print layer 119 and a bottom print layer 121. In addition, a pair of opposing transparent overlays 123 and 125 is disposed on the top and bottom surfaces, respectively, of the stack. To form the unitary card body 113, layers 117, 119, 121, 123 and 125 are then permanently joined together by any conventional means, such as through a lamination process.

The principal distinction between plastic card body 113 and plastic card body 13 relates to the orientation of its associated RF inlay. Specifically, card body 13 is formed with RF inlay 17 disposed in its natural orientation (i.e., with flat top surface 31 facing upward). By comparison, card body 113 is formed with RF inlay 117 flipped upside down, or inverted, (i.e., with its flat top surface 131 facing downward). Accordingly, radio frequency antenna 135, which is still preferably in the form of a 100 μm diameter copper wire, is effectively positioned along the underside of core layer 127 (i.e., adjacent bottom print layer 121).

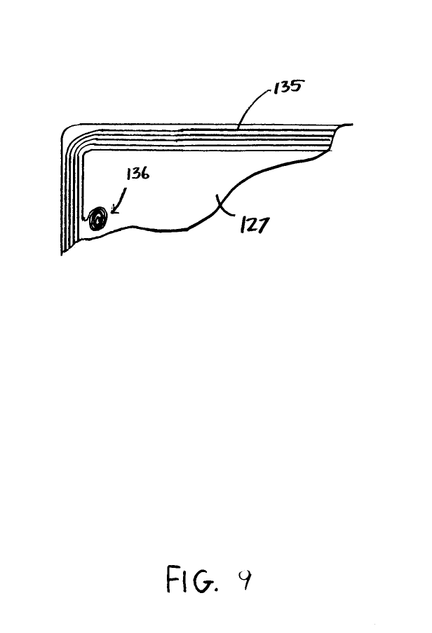

As seen most clearly in FIG. 9, RF antenna 135 is preferably arranged as a continuous, non-insulated wire strand that wraps, or coils, about the periphery of core layer 127. Preferably, one end of antenna 135 terminates into a densely configured pattern, such as a tightly wrapped coil, spiral or zig zag formation, to yield a contact terminal 136 that is aligned directly beneath a corresponding contact pad 155 in IC module 115.

Preferably, antenna 135 is so densely configured at contact terminal 136 that the non-insulated wire used to form antenna 135 contacts itself at numerous locations. The dense, self-contacting configuration of the non-insulated wire used to form contact terminal 136 ensures that when each of the pair of bores 160 (only one of which is shown in FIG. 7) is routed, or drilled, down into shelf 139, a segment of the non-insulated copper wire is rendered exposed for direct contact thereto, thereby eliminating the need for an additional, separately die cut, conductive contact pad to be directly welded onto antenna 135 to facilitate electrical connection with IC module 15. In addition, it should be noted that the dense, self-contacting configuration of the non-insulated wire used to form contact terminal 136 ensures that if a portion of contact terminal 136 is cut during the bore routing process, the remaining exposed portion of the non-insulated copper wire is not severed from the remainder of antenna 135 (which would otherwise render it non-functional).

Referring back to FIG. 7, smart card 111 is similar to smart card 11 in that smart card utilizes first and second opposing conductive elements 161-1 and 161-2 as well as a supply of conductive filler material (not shown) to encapsulate elements 161. Specifically, each conductive element 161 is preferably constructed out a length of thin wire that is formed from a highly conductive material, such as gold or aluminum, and configured as a U-shaped staple with a generally straight base portion 163 and a pair of opposing, inwardly curved spring arms 165.

Accordingly, the base portion 163 of first conductive element 161-1 is permanently welded to one or more strands of exposed RF antenna 135 with its spring arms 165 protruding in the upward direction towards contact pad 155. Preferably, each spring arm 165 for conductive element 161-1 is of a length greater than the depth of routed bore 160 to promote contact with contact pad 155 and/or second conductive element 161-2 when smart card 11 is in its fully assembled form.

Similarly, base portion 163 of second conductive element 161-2 is permanently welded to contact pad 155 with its spring arms 165 protruding in the downward direction towards the one or more strands of exposed RF antenna 135. Preferably, each spring arm 165 for second conductive element 161-2 is of a length greater than the depth of routed bore 160 to promote contact with exposed strands of RF antenna 135 and/or first conductive element 161-1 when smart card 11 is in its fully assembled form.

As noted briefly above, a supply of conductive filler material, which is preferably constructed of a low durometer silicone, is deposited into routed bore 160 so as to encapsulate the majority of the length of arms 165 for first and second conductive elements 161-1 and 161-2. In this manner, the filler material serves to conductively couple first and second conductive elements 161-1 and 161-2, thereby providing redundant electrical connection between IC module 115 and RF antenna 135, which is a principal object of the present invention.

It should be noted that by inverting RF inlay 117, the depth of routed bore 160 is lengthened considerably. As a result, the length, or area, of contact between first and second conductive elements 161-1 and 161-2 is substantially increased. Accordingly, by extending the area of contact between elements 161, it is to be understood that a more robust, reliable and secure connection is established between IC module 115 and RF antenna 135, which is highly desirable.

What is claimed is:

1. A smart card, comprising:
(a) a card body, the card body comprising an antenna,
(b) an integrated circuit (IC) module coupled to the card body, the IC module comprising an IC chip and a contact pad electrically coupled to the IC chip, and
(c) a first conductive element for electrically coupling the IC module to the antenna, the first conductive element being permanently conductively coupled to one of the antenna and the contact pad, the first conductive element having a first end that is adapted to resiliently electrically contact the other of the antenna and the contact pad, the first conductive element being adapted to flex to the extent necessary to maintain electrical contact with the other of the antenna and the contact pad upon movement of the IC module relative to the card body.

2. The smart card as claimed in claim 1 wherein the first conductive element comprises a plurality of individual conductive strands that are braided together.

3. The smart card as claimed in claim 2 wherein each of the plurality of conductive strands is in the form of a tin-plated copper wire.

4. The smart card as claimed in claim 2 wherein the first end of the first conductive element is at least partially frayed.

5. The smart card as claimed in claim 4 wherein the first conductive element comprises a second end that is at least partially frayed.

6. The smart card as claimed in claim 4 further comprising a second conductive element, the second conductive element being permanently conductively coupled to the other of the antenna and the contact pad, the second conductive element having a first end that is adapted to resiliently electrically contact the one of the antenna and the contact pad, the second conductive element being adapted to flex to the extent necessary to maintain contact with the one of the antenna and the contact pad upon movement of the IC module relative to the card body.

7. The smart card as claimed in claim 6 wherein the second conductive element comprises a plurality of individual conductive strands that are braided together.

8. The smart card as claimed in claim 7 wherein the first end of the second conductive element is at least partially frayed.

9. The smart card as claimed in claim 8 wherein the second conductive element comprises a second end that is at least partially frayed.

10. The smart card as claimed in claim 8 wherein the first end of the first conductive element directly contacts the first end of the second conductive element.

11. The smart card as claimed in claim 8 wherein the first end of the first conductive element is conductively coupled to the first end of the second conductive element through multiple points of contact.

12. The smart card as claimed in claim 11 wherein the first end of the first conductive element at least partially entangles the first end of the second conductive element.

13. The smart card as claimed in claim 10 further comprising a supply of conductive filler material that encapsulates at least a portion of the first end for each of the first and second conductive elements.

14. The smart card as claimed in claim 13 wherein the supply of conductive filler material is in the form of a low durometer conductive silicone.

15. The smart card as claimed in claim 1 wherein the antenna terminates into a densely configured contact terminal.

16. The smart card as claimed in claim 15 wherein the antenna is formed using a non-insulated wire.

17. The smart card as claimed in claim 16 wherein the non-insulated wire contacts itself at a plurality of locations within the densely configured contact region.
